(19) United States
(12) Patent Application Publication
(10) Pub. No.: US 2012/0292143 A1
(43) Pub. Date: Nov. 22, 2012

(54) Magnetorheological Damper With Annular Valve

(76) Inventors: Eric Anderfaas, Westminster, CA (US); Peter LeNoach, Irvine, CA (US); James Robinson, Newport Beach, CA (US); Jared Trauernicht, Huntington Beach, CA (US); Mathew Torgerson, Aliso Viejo, CA (US)

(21) Appl. No.: 12/883,999

(22) Filed: Sep. 16, 2010

Related U.S. Application Data
(63) Continuation of application No. 11/471,932, filed on Jun. 21, 2006, now abandoned.
(60) Provisional application No. 60/692,449, filed on Jun. 21, 2005.
(60) Provisional application No. 60/762,334, filed on Jan. 25, 2006.

(51) Int. Cl. F16F 9/53

(52) U.S. Cl. 188/267.2

(57) ABSTRACT

A magnetorheological damper device is provided having a high-bandwidth and high-control ratio, which enhances the performance of the damper. The damper generally includes a cylindrically shaped housing; a magnetorheological fluid disposed in the cylindrically shaped housing; a piston assembly disposed within the cylindrically shaped housing in sliding engagement with the cylindrically shaped housing defining a first chamber. The first chamber is in communication with a second chamber, through a magnetorheological valve assembly which comprises of a plurality of cylindrically shaped fluid passageways extending from the first chamber to the second chamber, and an electromagnet; and a power supply in electrical communication with the electromagnet.

### RELATED APPLICATIONS

This application is a continuation of U.S. patent application Ser. No. 11/471,932 filed Jun. 21, 2006 entitled Magnetorheological Damper With Annular Valve (as amended), which claims priority to U.S. Provisional Application Ser. No. 60/692,449 filed Jun. 21, 2005 entitled Linear Magnetorheological Damper With Fixed Annular Valve and to U.S. Provisional Patent Application Serial No. 60/762,334 filed Jun. 25, 2005 entitled Reduced Height Linear Magnetorheological Damper With Integrated Gas Spring, both of which are hereby incorporated by reference.

### BACKGROUND OF THE INVENTION

The present invention generally relates to linear vibration dampers. More specifically, the present invention relates to a linear vibration damper utilizing a magnetorheological (MR) fluid.

Conventional linear vibration dampers include MR dampers having a cylinder containing MR fluid and a piston which slidably engages the cylinder. The MR fluid passes though an orifice on the piston. Exposing the MR fluid in the orifice to a magnetic field generated by an electrical coil located within the piston causes a change in the shear strength of the fluid flowing through the orifice, providing variable damping of relative motion between the piston and cylinder. The damping force is controllable by varying the strength of the magnetic field generated by the piston coil. To improve the control ratio (the damping force created by a fully energized coil divided by the damping force of a de-energized coil) of the damper, many MR damper pistons utilize an annular orifice. The width of the annular orifice in these devices must be precisely maintained to provide a predictable, repeatable change in damping force when a current is applied to the coil. Also, a magnetic flux return path outside of the fluid flow path is necessary to achieve a higher control ratio. Often in these devices, a compromise must be made between maximizing the flow area of the annular orifice (producing a higher control ratio) and the need to provide a durable bearing surface on the exterior of the piston (providing a longer damper service life). If this bearing surface is constructed from a magnetically-permeable material, it can also serve as the flux return path, but at the expense of reduced annular flow area and a corresponding reduction in control ratio.

It is also desirable to incorporate a gas spring into the vibration damper. Properly integrated, the gas spring can serve several purposes. It can prevent cavitation of the MR fluid by eliminating low pressure regions during damper compression and extension. When utilized as part of the suspension of a ground vehicle, the gas springs can be connected to a reservoir of high pressure gas through controllable valves and used to adjust the ride height of a vehicle to compensate for changing payloads as well as supporting the vehicle's sprung mass.

Therefore, a need exists for a damper with a very high control ratio, an integrated gas spring, and a relatively long service life.

### OBJECTS AND SUMMARY OF THE INVENTION

One object of the present invention is to provide a high-bandwidth adjustable vibration damping between two components of a system experiencing relative motion. Such systems include but are not limited to: the suspension systems of ground vehicles which operate on smooth roads, the suspension systems of ground vehicles which operate on roads and also in rough terrain, the steering systems of ground vehicles, aircraft landing gear, washing machine drum vibration control systems, shock load attenuating devices, and impact load attenuating devices. It will be apparent to those skilled in the art that a system in accordance with the present invention can be used in virtually any application where a conventional passive damper is used, regardless of the construction of the passive damper.

In one aspect of the present invention, the damper system utilizes a fixed annular valve instead of a piston-mounted valve, thereby separating the function of fluid sealing from the function of damping force generation. This allows the annular valve area to be maximized while also maintaining a precise distance between the flux core and the flux return path. In this regard, a large flowpath diameter is one that is larger than the piston head diameter, or, in the case of preferred embodiment two, larger than the internal concentric tube. Thus, for the same off-state pressure drop across the valve, the flowpath gap (defined as the Outer Radius of the flowpath minus the Inner Radius of the flowpath) can be narrower and achieve a higher on-state pressure drop, which means a higher control ratio.

In another aspect of the present invention, a damper system incorporates a gas spring in fluid communication with the MR fluid chamber to prevent cavitation of the MR fluid and also to serve as a steady-state support for the vehicle. Such a gas spring may be of the fixed spring rate, sealed chamber type or it may also be in fluid communication with a pneumatic reservoir to provide adjustable vehicle ride height (adjustable spring preload) or adjustable spring rate.

In another aspect of the present invention, an annular valve includes of a flux core made of one or more stacked coils which can be energized independently or simultaneously by a control system. One such control system that could be used is the control system disclosed in U.S. Pat. No. 6,953,108 entitled Magnetorheological Damper System, the contents of which are hereby incorporated by reference. Such a control system can include a routine for energizing one or more of said coils in response to at least one sensed condition of said damper so as to dampen forces exerted on said damper.

There are several preferred embodiments for this invention. A first, henceforth referred to as Preferred Embodiment One, minimizes overall damper length as well as providing the highest control ratio and low pressure losses throughout the fluid path. Another preferred embodiment, henceforth referred to as Preferred Embodiment Two, is less linearly compact as Preferred Embodiment One, but is lighter, less complex, and more efficiently manufactured.

### BRIEF DESCRIPTION OF THE DRAWINGS

The present invention will now be described, by way of example, with reference to the accompanying drawings, in which:

FIG. 1 is a cross-sectional view of a first preferred embodiment of an MR damper in accordance with the present invention.

FIG. 2 is a detail view of FIG. 1.

FIG. 3 is an additional cross-sectional view of the MR damper of FIG. 1.

FIG. 4 is a detail view of FIG. 3 showing the fluid flow direction during a compression stroke.

FIG. 5 is a cross-sectional view of a second preferred embodiment of a MR damper in accordance with the present invention.

FIG. 5A is a detail view of FIG. 5.

FIG. 6 is a cross-sectional view of the annular valve assembly of FIG. 5.

FIG. 7 is a cross-sectional view of a third preferred embodiment of an MR damper in accordance with the present invention.

FIG. 7A is a detail view of FIG. 7.

FIG. 8 is a cross-sectional view of a fourth preferred embodiment of a MR damper in accordance with the present invention.

FIG. 8A is a detail view of FIG. 8.

FIG. 9 is a prior art twin-tube damper shown in the extended and retracted positions.

FIG. 10 illustrates a damping control ratio.

FIG. 11 illustrates a damping control ratio.

### DETAILED DESCRIPTION OF THE INVENTION

Discussed below is a detailed description of several preferred embodiments of the present invention. This detailed description is not meant to be limiting but rather to illustrate the general principles of the present invention. Departures may be made from such details without departing from the scope or spirit of the general inventive concept. Those skilled in the art will appreciate that the principles constituting the invention can be applied with great success to any number of applications that require management of shock and vibration forces.

### Prior Art Damper

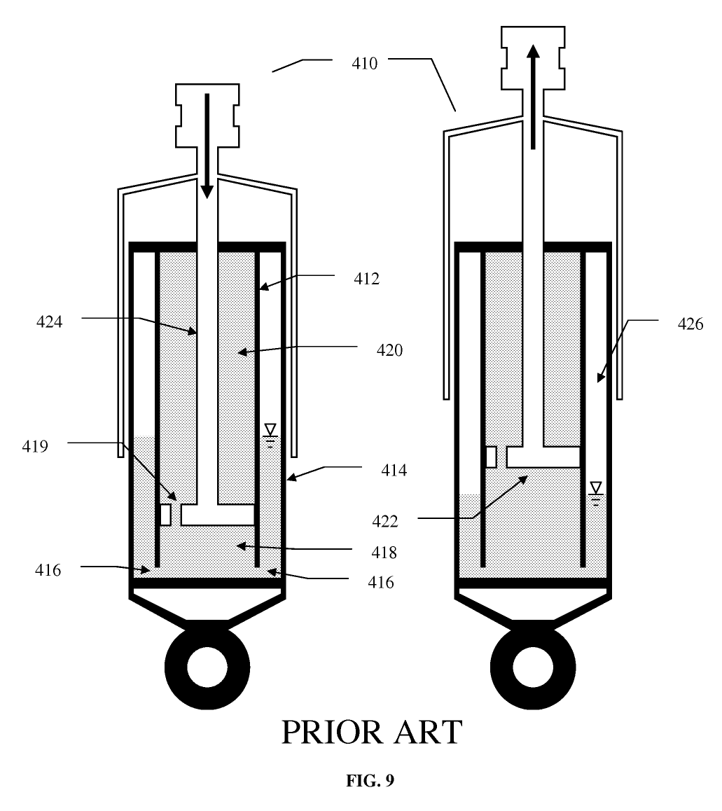

FIG. 9 depicts a cross-sectional view of a prior art conventional twin-tube vibration damper 410 consisting of inner cylinder 412 and outer cylinder 414 which are in fluid communication through fluid ports 416. During the compression stroke of vibration damper 410, hydraulic fluid flows from lower fluid chamber 418 of inner cylinder 412 through orifice 419 and into upper fluid chamber 420 while piston 422 descends, increasing the volume of piston rod 424 which is immersed in hydraulic fluid. To compensate for this increased rod volume, gas 426 is compressed, occupying a smaller volume within outer cylinder 414. For the extension stroke of vibration damper 410, the flow is reversed through orifice 419 as piston 422 ascends and a decreased volume of piston rod 424 is immersed in hydraulic fluid. To compensate for this decreased rod volume, gas 426 expands, occupying a larger volume within outer cylinder 414.

### Preferred Embodiment One

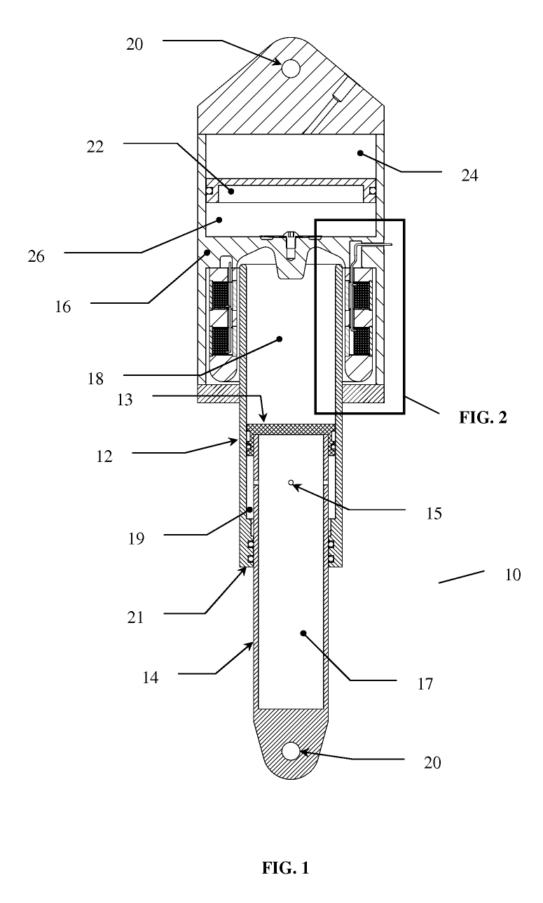

FIG. 1 depicts a cross-sectional view of Preferred Embodiment One of a vibration damper 10, in accordance with various aspects of the present invention, having an outer housing assembly 12 and an inner cylinder tube piston assembly 14. Integrated into the center of the outer housing assembly 12 is annular valve 16 which defines an upper fluid chamber 26 and a lower fluid chamber 18 to contain a magnetorheological (MR) working fluid therein. Since piston assembly 14 is only exposed to fluid on the upper face of piston head 13, no rod volume compensator gas 426 is necessary in contrast to the prior art damper shown in FIG. 9. Since gas 426 is a thermal insulator, vibration damper 10 functions without the excessive heat buildup of vibration damper 410. Piston assembly 14 can be perforated by at least one pressure equalization hole 15, allowing fluid communication between inner piston chamber 17 and air chamber 19 to prevent excessive pressure buildup in air chamber 19 as piston assembly 14 moves with respect to outer housing assembly 12. Pressure buildup may also be prevented by creating at least one vent hole in piston seal flange 21, allowing fluid communication between air chamber 19 and atmospheric air. Outer housing assembly 12 is further divided by dynamic separator piston 22 which defines a gas chamber 24. Gas chamber 24 contains a compressible gas, which acts as a spring to prevent cavitation of the MR working fluid in upper chamber 26 and also to provide a steady-state resistance force between two components of a system experiencing relative motion, such as a ground vehicle's chassis and wheel. At the opposing ends of vibration damper 10 are two clevis eyes 20, providing attachment points between two components of a system experiencing relative motion, such as a ground vehicle's chassis and wheel.

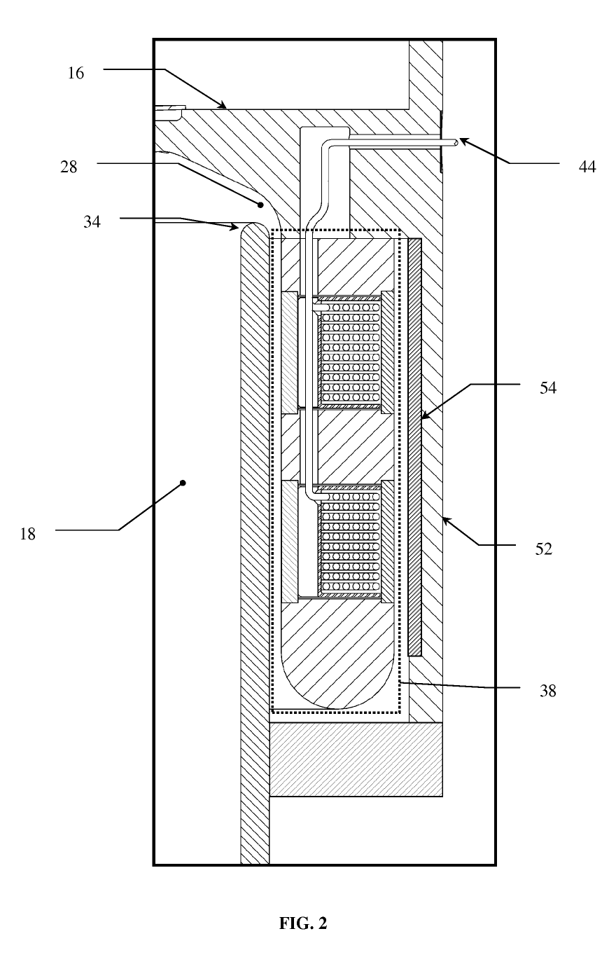

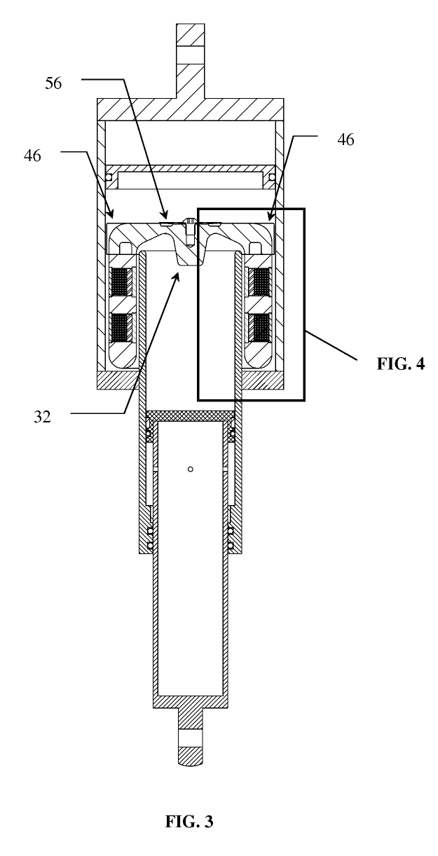

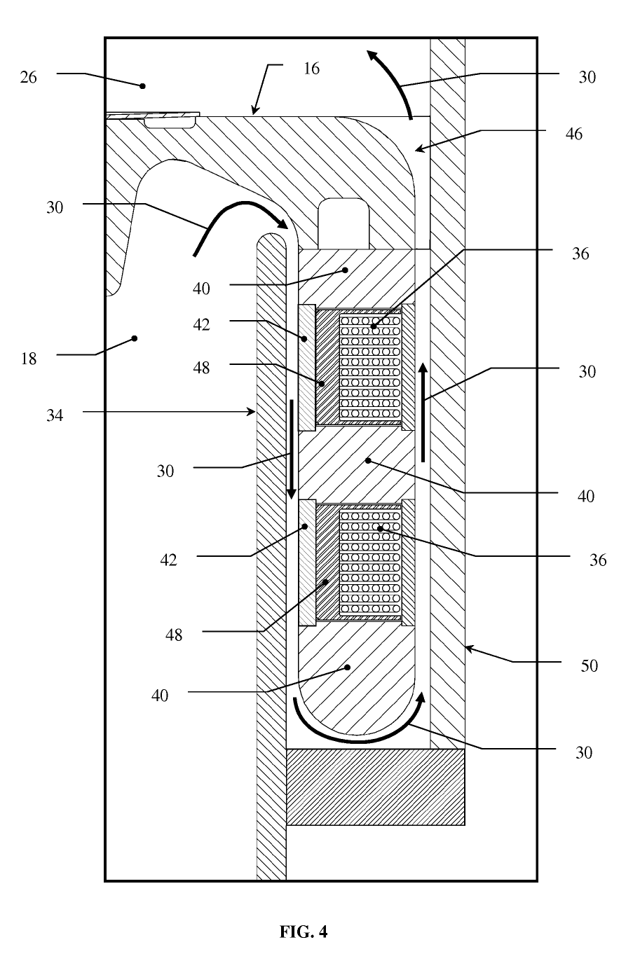

A detail view of annular valve 16 is shown in FIG. 2 and an additional cross-sectional view of vibration damper 10 is shown in FIG. 3. FIG. 4 is a detailed close up view of FIG. 3 for clearer understanding of annular flow path 30.

During the compression stroke of the vibration damper 10, fluid leaves lower fluid chamber 18 and enters annular valve inlet 28. MR fluid flow is efficiently directed into annular valve inlet 28 to annular flow path 30 by center body nosecone 32 and magnetically-permeable inlet side wall 34, where it is exposed to a variable magnetic field generated by at least one electromagnetic coil 36. Annular flow path 30 travels down one side of magnetic coil stack 38, around the bottom and then up between magnetic coil stack 38 and magnetically-permeable outer side wall 48. If desired, magnetically-permeable outer side wall 50 can be replaced by a magnetically-impermeable outer side wall 52 and a magnetically-permeable sleeve 54 as shown. This exposes the MR fluid to the magnetic flux generated by electromagnetic coils 36 a second time, providing a relatively long magnetic flux-affected flow length with a smaller number of electromagnetic coils 36 than is possible with other embodiments while maintaining a the same high control ratio. By using fewer electromagnetic coils 36 electrical inductance is reduced, thereby increasing the damping response rate without reducing the control ratio. Each electromagnetic coil 36 is wound on bobbin 48 for ease of assembly, positioned on a magnetically-permeable ring 40, and covered by magnetically-impermeable covers 42 front and back. Each electromagnetic coil 36 is connected to an electrical current source via electrical leads 44 and can be independently energized, allowing precise tailoring of the damping forces generated by vibration damper 10. In this embodiment, electrical leads 44 are completely isolated from gas chamber 24, eliminating the need to provide a sealing mechanism to prevent gas from gas chamber 24 from leaking into and being absorbed by the magnetorheological fluid contained in vibration damper 10. After passing through annular path 30 the MR fluid is efficiently directed through a series of radial ports 46 of annular valve 16 and into upper fluid chamber 26. Since no gas reservoir is required to compensate for the changing rod volume as in the conventional twin-tube damper shown in FIG. 9, heat which is generated in the magnetorheological fluid during the compression and extension of vibration damper 10 is conducted efficiently to outer side wall 52 where it is rejected to atmosphere. To mitigate the effects of an extremely rapid compression of the damper, blow-off valve 56 allows for an increased fluid flow rate between lower fluid chamber 18 and upper fluid chamber 26. Blow-off valve 56 automatically closes during the rebound stroke of the damper, forcing all fluid flowing between upper fluid chamber 26 and lower fluid chamber 18 to follow annular path 30. For the rebound stroke of the vibration damper 10 the flow is reversed, starting in upper fluid chamber 26, proceeding through radial ports 46, through annular path 30, out annular valve inlet 28 and into lower fluid chamber 18.

### Preferred Embodiment Two

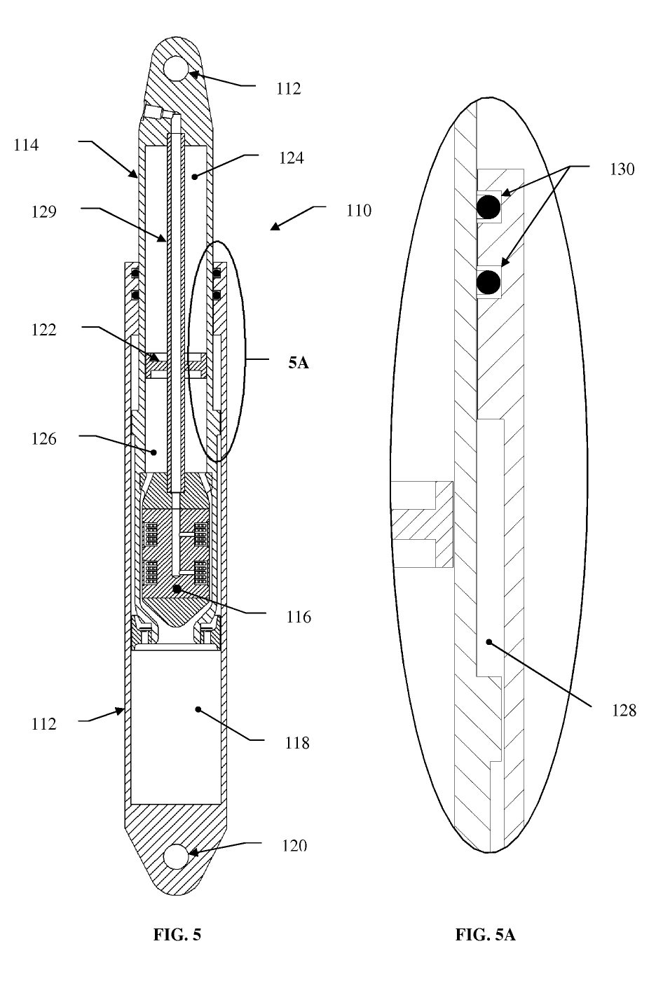

FIG. 5 and FIG. 5A depict a cross-sectional view of Preferred Embodiment Two of a vibration damper 110, according to various aspects of the present invention, having an outer cylinder tube 112 and an inner cylinder tube 114. Attached to the lower end of inner cylinder tube 114 is annular valve 116 which defines an upper fluid chamber 126 and a lower fluid chamber 118 to contain a magnetorheological (MR) working fluid therein. Annular chamber 128 exists in the area between outer cylinder tube 112, inner cylinder tube 114, and outer cylinder fluid seals 130. Inner cylinder tube 114 is further divided by dynamic separator piston 122 which defines a gas chamber 124. Gas chamber 124 contains a compressible fluid or gas, which acts as a spring to prevent cavitation of the MR working fluid in upper chamber 116 and also to provide a steady-state resistance force between two components of a system experiencing relative motion, such as a ground vehicle's chassis and wheel. Protruding through dynamic separator piston 122 is wiring tunnel 129, which isolates the wiring for annular valve 116 from the gas in gas chamber 124 and the MR fluid in upper fluid chamber 126. Using solid core wires through gas path instead of stranded wires aids sealing. An O-ring is used instead of, for example, a crimped ferrule as shown in prior art U.S. Pat. No. 5,878,851, the contents of which is incorporated by reference. More particularly, the referenced prior art patent uses a crimped ferrule around a single wire and a damper body common instead of two wires as in this embodiment.

At the opposing ends of vibration damper 110 are two clevis eyes 120, providing attachment points between two components of a system experiencing relative motion, such as a ground vehicle's chassis and wheel.

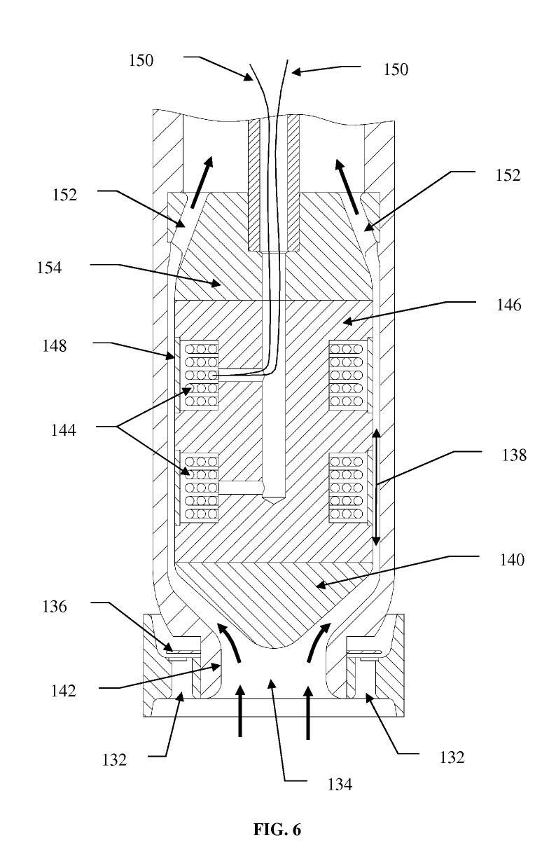

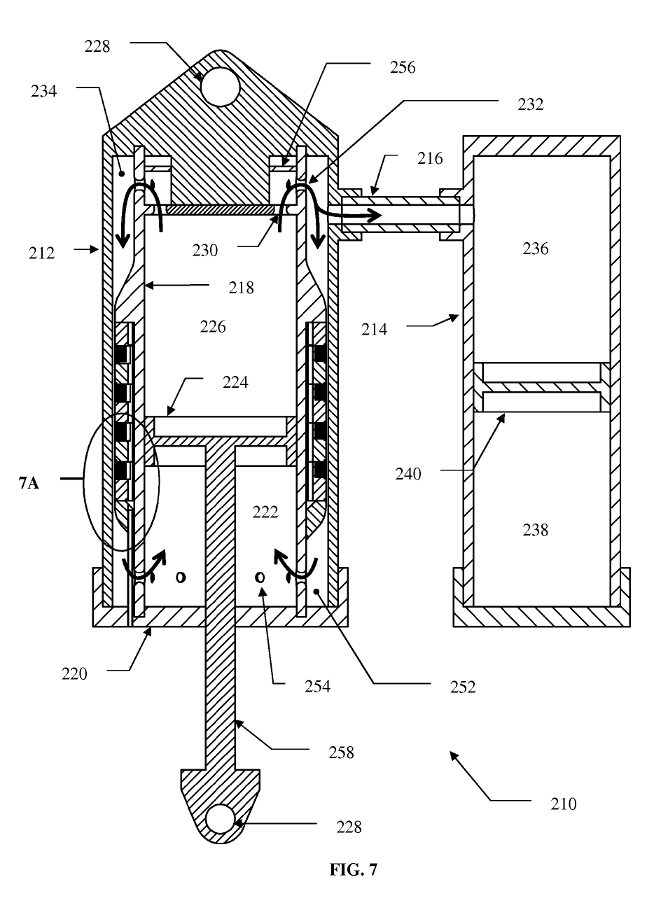

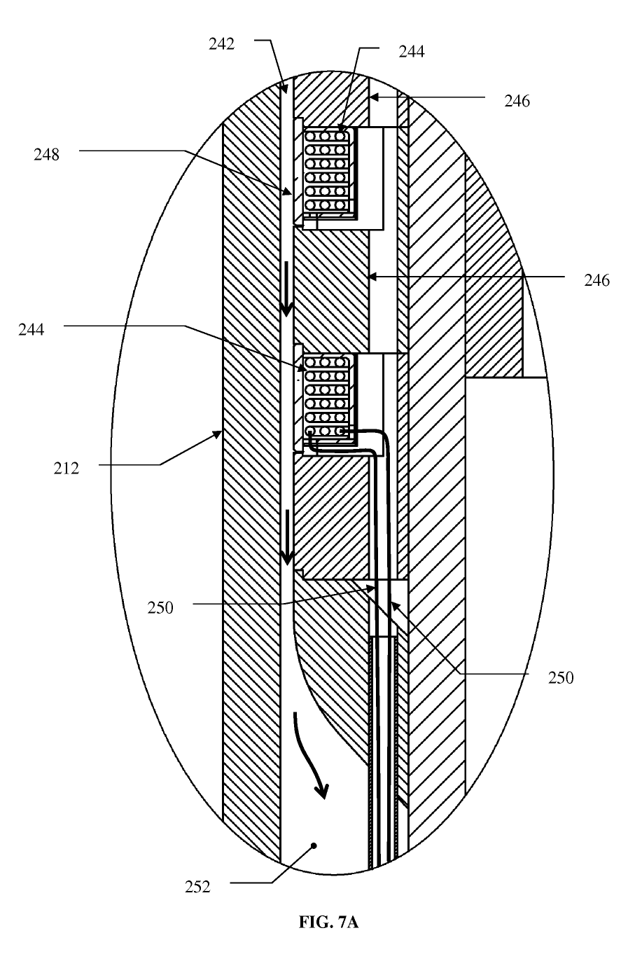

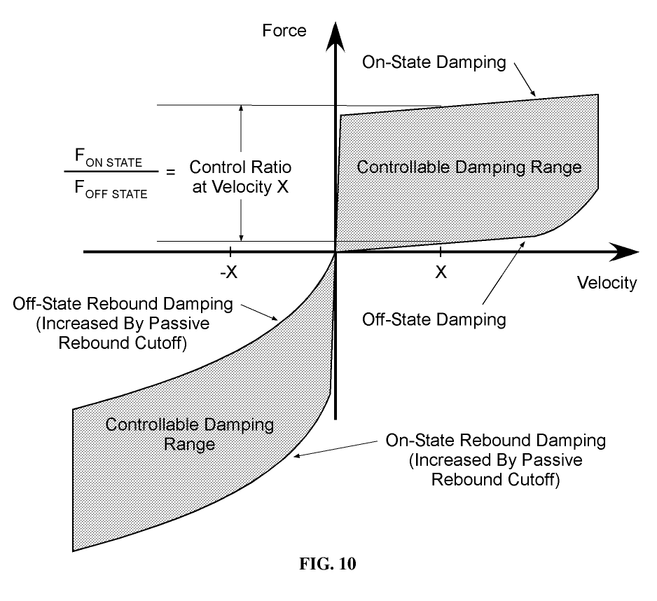

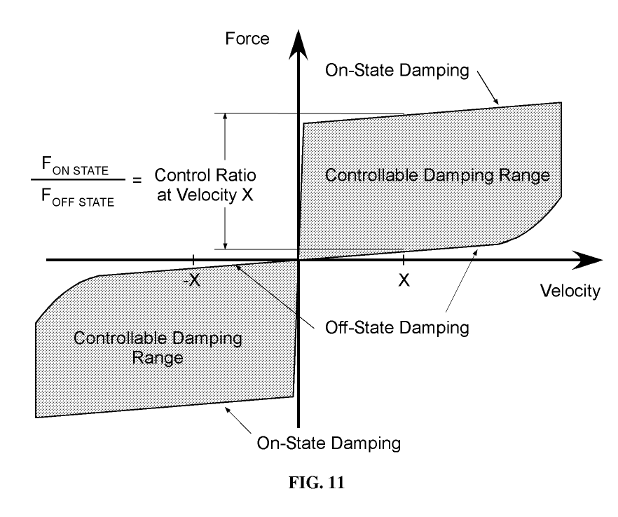

A detail cross-section of annular valve 116 is shown in FIG. 6. Fluid enters and exits annular chamber 128 through an array of flow ports 132 spaced around annular valve inlet 134. Check plate 136 provides a greatly reduced flow rate through flow ports 132 during the rebound stroke of vibration damper 110. This use of a passive rebound cutoff allows the high control ratio of damper 110 to be employed entirely in the compression stroke of vibration damper 110 as shown in FIG. 10 instead of being split between the compression stroke and the rebound stroke as in FIG. 11. As a result, control ratio can be maximized in the desired region of jounce instead of being spread across both jounce and rebound regions.

In connection with an example of high control ratios, preferred embodiment one and two will preferably provide a control ratio of approximately 8-12, and more preferably a ratio of about ten 10. Prior art MR dampers typically have a control ratio of 2.0 or 3.0.

During the compression stroke of vibration damper 110, fluid leaves lower fluid chamber 118 and enters annular valve inlet 134. MR fluid flow is efficiently directed around valve centerbody 154 to annular path 138 by centerbody nosecone 140 and inlet sidewall 142, where it is exposed to a variable magnetic field generated by a one or more electromagnet coils 144. Each electromagnet coil 144 is wound on a bobbin for ease of assembly, positioned over a magnetically-permeable modular core 146, and covered by a magnetically-impermeable coil cover 148. Each electromagnet coil 144 is connected to an electrical current source via electrical leads 150 and is independently energizable, allowing precise tailoring of the damping forces generated by vibration damper 110. After passing through annular path 138 the MR fluid is efficiently directed through a series of radially-spaced exhaust ports 152 of valve centerbody 154 and into upper fluid chamber 126. For the rebound stroke of vibration damper 110 the flow is reversed, starting in upper fluid chamber 126, proceeding through exhaust ports 152, through annular path 138, out annular valve inlet 134 and into lower fluid chamber 118.

### Preferred Embodiment Three

FIG. 7 and FIG. 7A depict a cross-sectional view of a third preferred embodiment in accordance with aspects of the present invention. This third preferred embodiment has the high control ratio and long service life of previous embodiments, but can be utilized in applications where the overall length of the vibration damper must be minimized. Vibration damper 210 consists of a magnetically-permeable main cylinder 212 which contains a magnetorheological (MR) working fluid therein and secondary cylinder 214 in fluid communication with said main cylinder via flexible hose 216. Main cylinder 212 contains a concentric inner cylinder 218 held in position with cylinder end cap 220. Inner cylinder 218 is divided into upper piston chamber 226 and lower piston chamber 222 by piston 224. At the opposing ends of vibration damper 210 are two clevis eyes 228, providing attachment points between two components of a system experiencing relative motion, such as a ground vehicle's chassis and wheel. During the compression stroke of vibration damper 210, upward motion of piston 224 forces fluid out of upper piston chamber 226, through rebound cutoff port 230, through upper flow ports 232 and into upper valve chamber 234. Said upper valve chamber is in fluid communication with secondary fluid chamber 236, which is contained within secondary cylinder 214 and separated from compressible gas chamber 238 by secondary piston 240. Said gas chamber contains a compressible gas which pressurizes the MR fluid, thus preventing cavitation of the MR fluid during compression and rebound of vibration damper 210. Fluid displaced from main cylinder 212 by intrusion of piston rod 258 into said main cylinder flows into secondary fluid chamber 236, further compressing the gas contained within gas chamber 238.

Fluid leaves upper valve chamber 234 and is efficiently directed into annular valve 242, where it is exposed to a variable magnetic field generated by a one or more electromagnet coils 244. Each electromagnet coil 244 is wound on a bobbin for ease of assembly, positioned over a magnetically-permeable modular core 246, and covered by a magnetically-impermeable coil cover 248. Each electromagnet coil 244 is connected to an electrical current source via electrical leads 250 and is independently energizable, allowing precise tailoring of the damping forces generated by vibration damper 210. After passing through annular valve 242 the MR fluid is efficiently directed into lower valve chamber 252, through lower flow ports 254 and into lower piston chamber 222. For the rebound stroke of vibration damper 210 the flow is reversed, starting in lower piston chamber 222, proceeding through lower flow ports 254, through annular valve 242, into upper valve chamber 234 and through upper flow ports 232. During the reversed flow conditions of the rebound stroke rebound cutoff plate 256 covers rebound cutoff port 230, greatly reducing fluid flow rate through rebound cutoff port 230 and into upper piston chamber 226.

### Fourth Preferred Embodiment

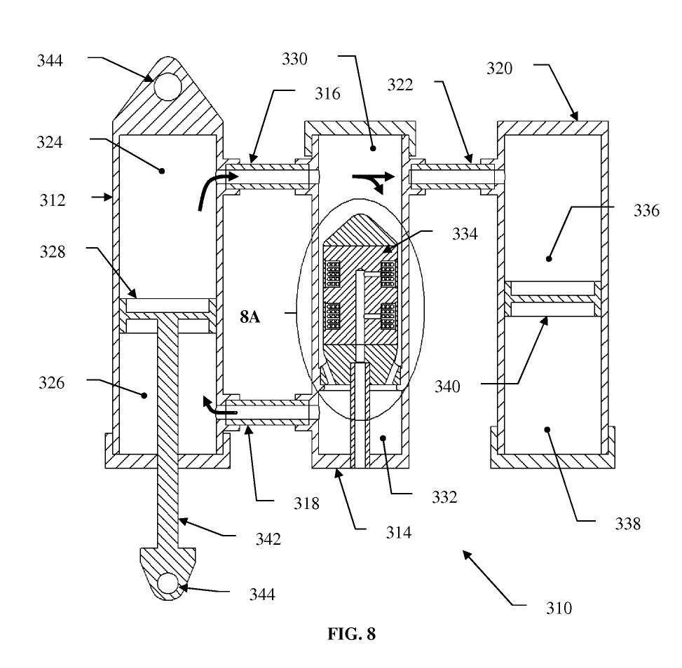

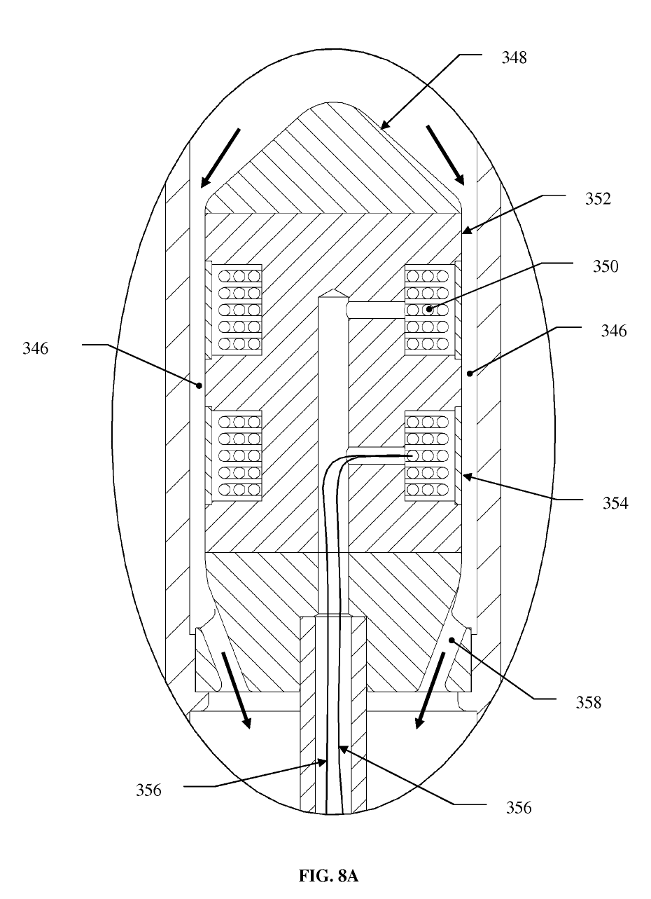

FIG. 8 and FIG. 8A depict a cross-sectional view of a fourth preferred embodiment in accordance with aspects of the present invention. This fourth embodiment has the high control ratio and long service life of the preferred embodiment, but can be utilized in applications where the overall length and diameter of the vibration damper must be minimized. Vibration damper 310 consists of; main cylinder 312, which contains a magnetorheological (MR) working fluid therein; a valve cylinder 314, which is in fluid communication with said main cylinder via upper flexible hose 316 and lower flexible hose 318; and gas cylinder 320, which is in fluid communication with said valve cylinder via flexible hose 322. At the opposing ends of main cylinder 312 are two clevis eyes 344, providing attachment points between two components of a system experiencing relative motion, such as a ground vehicle's chassis and wheel. Main cylinder 312 is divided into upper piston chamber 324 and lower piston chamber 226 by piston 328. Valve cylinder 314, which is constructed from a magnetically-permeable material, is divided into upper valve chamber 330 and lower valve chamber 332 by valve centerbody 334. Gas cylinder 320 is divided into fluid chamber 336 and gas chamber 338 by secondary piston 340. Gas chamber 338 contains a compressible gas which pressurizes the MR fluid, thus preventing cavitation of the MR fluid during compression and rebound of vibration damper 310. Fluid displaced from main cylinder 212 by intrusion of piston rod 242 into said main cylinder flows into fluid chamber 236, further compressing the gas contained within gas chamber 238.

During the compression stroke of vibration damper 310, upward motion of piston 328 forces fluid out of upper piston chamber 324 and into upper valve chamber 330 via upper flexible hose 316. MR fluid flow is efficiently directed around valve centerbody 334 to annular path 346 by centerbody nosecone 348, where it is exposed to a variable magnetic field generated by a one or more electromagnet coils 350. Each electromagnet coil 350 is wound on a bobbin for ease of assembly, positioned over a magnetically-permeable modular core 352, and covered by a magnetically-impermeable coil cover 354. Each electromagnet coil 350 is connected to an electrical current source via electrical leads 356 and is independently energizable, allowing precise tailoring of the damping forces generated by vibration damper 310. After passing through annular path 346 the MR fluid is efficiently directed through a series of radially-spaced exhaust ports 358 of valve centerbody 334 and into lower fluid chamber 332. Fluid leaves lower fluid chamber 332 and enters lower piston chamber 326 via lower flexible hose 318. For the rebound stroke of vibration damper 310 the flow is reversed, starting in lower piston chamber 326, proceeding through lower flexible hose 318, into lower fluid chamber 332, into exhaust ports 358, through annular path 346 and into upper valve chamber 330. Fluid then flows into upper piston chamber 324 via upper flexible hose 316.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A vibration damping system comprising:
a housing assembly having a first cylinder, a second cylinder, and a piston, said first and second cylinders disposed outside of one another, said piston disposed within said first cylinder and movable relative to said first cylinder;
a magnetorheological fluid sealed within said housing assembly;
an electromagnetically-actuated annular valve disposed in said second cylinder of said housing assembly controlling said relative movement of said first cylinder and said piston by controlling movement of said magnetorheological fluid between said first and second cylinders; and
a gas chamber disposed in said housing assembly and in pneumatic communication with said magnetorheological fluid;
said gas chamber having a dual function of preventing cavitation of said magnetorheological fluid and for providing substantially steady state resistance force between said first cylinder and said piston.

2. The vibration damping system according to claim 1, further comprising a reservoir disposed outside of said housing assembly and in fluid communication with said gas chamber, said reservoir being controllable so as to increase a volume of gas present in said gas chamber.

3. A vibration damping system comprising:
a housing assembly having a first tube telescopingly disposed within and movable relative to a second tube;
an magnetorheological working fluid sealed within said housing assembly; and
an annular valve controlling said relative movement of said first and second tubes by controlling movement of said magnetorheological working fluid;
said annular valve having at least one electromagnetic coil that generates a magnetic field and an annular magnetorheological fluid activation pathway that directs said magnetorheological working fluid so as to be approximately contemporaneously affected by said magnetic field of said at least one electromagnetic coil a plurality of times.

4. The vibration damping system according to claim 3 wherein said annular magnetorheological fluid activation pathway is approximately contemporaneously affected by said magnetic field of said at least one electromagnetic coil a plurality of times at parallel portions of said magnetorheological fluid activation pathway.

5. The vibration damping system according to claim 3, further comprising a blow-off valve in fluid communication with said magnetorheological working fluid.

6. A vibration damping system comprising:
a housing assembly having a cylinder portion and a piston portion, said piston portion movable within said cylinder portion;
a magnetorheological working fluid sealed within said housing assembly and displaceable between a first chamber and a second chamber formed within said housing assembly;
an annular valve controlling said relative movement of said cylinder and said piston portions by controlling movement of said magnetorheological working fluid;
said piston portion comprising a piston face and a piston rod, said piston face in direct contact with said magnetorheological fluid, said piston rod isolated from contact with said magnetorheological working fluid.

7. The vibration damper of claim 6 further comprising a blow-off valve in fluid communication with said magnetorheological working fluid.

8. The vibration damper of claim 6 further comprising a gas chamber disposed in said housing assembly and in pneumatic communication with said magnetorheological working fluid having a dual function of preventing cavitation of said magnetorheological working fluid and for providing substantially steady state resistance force between said cylinder and piston portions.

9. The vibration damper of claim 1 further comprising a conductive element extending from said electromagnetically-actuated annular valve in said housing assembly through a passageway in said housing assembly to a power source located outside said housing assembly; said passageway bypassing said gas chamber.

10. The vibration damper of claim 1 further comprising a blow-off valve in fluid communication with said magnetorheological fluid.

11. The vibration damper of claim 3 further comprising a gas chamber disposed in said housing assembly and in pneumatic communication with said magnetorheological working fluid having a dual function of preventing cavitation of said magnetorheological working fluid and for providing substantially steady state resistance force between said first and second tubes.

12. The vibration damper of claim 3 wherein said annular magnetorheological fluid activation pathway is affected at least twice by said electromagnetic field outside of said at least one electromagnetic coil.

13. A vibration damping system comprising:
a cylinder;
a piston movable within the cylinder;
a magnetorheological fluid;
an annular valve disposed around the cylinder, the annular valve having an annular magnetorheological fluid flow path proximate an electromagnetic coil.

14. The vibration damper of claim 13 further comprising a gas chamber disposed in pneumatic communication with said magnetorheological fluid having a dual function of preventing cavitation of said magnetorheological fluid and for providing substantially steady state resistance force between said cylinder and said piston.

15. The vibration damper of claim 13 further comprising a blow-off valve in fluid communication with said magnetorheological fluid.

16. A vibration damping system comprising:
an outer cylinder having a first fluid chamber;
an inner cylinder comprising a second fluid chamber and a gas chamber, said inner cylinder movable within the outer cylinder;
an annular valve disposed within the inner cylinder such that a movement of the inner cylinder relative to the outer cylinder is communicated to the annular valve, the annular valve having at least one electromagnetic coil and an annular orifice disposed concentrically about said electromagnetic coil,
the annular orifice configured to direct a flow of a magnetorheological fluid between the first fluid chamber and the second fluid chamber.

17. The vibration damper of claim 16 further comprising a blow-off valve in fluid communication with said magnetorheological fluid.

18. The vibration damping system according to claim 1, further comprising a reservoir disposed outside of said housing assembly and in fluid communication with said gas chamber.

19. The vibration damping system according to claim 6 further comprising an annular magnetorheological fluid flow pathway that is affected at least twice by an electromagnetic field outside of at least one electromagnetic coil.
